(19) United States
(12) Patent Application Publication
(10) Pub. No.: US 2015/0201440 A1
(43) Pub. Date: Jul. 16, 2015

(54) BLUETOOTH Device Connection Method and Device

(71) Applicant: Huawei Device Co., Ltd., Shenzhen (CN)

(72) Inventors: Guangyuan Gao, Beijing (CN); Guoquan Zhang, Beijing (CN)

(21) Appl. No.: 14/669,624

(22) Filed: Mar. 26, 2015

Related U.S. Application Data
(63) Continuation of application No. PCT/CN2012/082223, filed on Sep. 27, 2012.

(51) Int. Cl. H04W 76/02; H04W 4/00

(52) U.S. Cl. CPC H04W 76/02; H04W 4/008

(57) ABSTRACT

A BLUETOOTH device connection method and device are provided. When BLUETOOTH devices are reconnected to each other after being interrupted due to a reason, a primary end device having a BLUETOOTH function proactively sends a connection request to a target BLUETOOTH device, so that a step of manually initiating a connection by a user is omitted, and a BLUETOOTH connection is established more timely, thereby improving BLUETOOTH communication efficiency.

### CROSS-REFERENCE TO RELATED APPLICATION

This application is a continuation of International Application No. PCT/CN2012082223, filed on Sep. 27, 2012, which is hereby incorporated by reference in its entirety.

### TECHNICAL FIELD

The present invention relates to the field of communications technologies, and in particular, to a BLUETOOTH device connection method and device.

### BACKGROUND

A BLUETOOTH technology is a radio technology supporting short-distance communication between devices, where wireless information exchange can be performed between various devices including mobile terminals, wireless headsets, notebook computers, removable hard disk drives, ebooks, relevant peripherals, and the like. By using the BLUETOOTH technology, communications between mobile communication terminal devices can be effectively simplified, and communications between a device and the Internet can also be simplified, so that data transmission becomes faster and more efficient.

However, when BLUETOOTH devices in a connected state are reconnected to each other after being interrupted due to a reason, a connection can be established only by manually pressing a button. In this case, many inconveniences are brought to a user, thereby reducing BLUETOOTH communication efficiency.

### SUMMARY

To solve technical problems, embodiments provide a BLUETOOTH device connection method and device, which can implement automatic establishment of a connection between BLUETOOTH devices without requiring a user to manually initiate the connection when the BLUETOOTH devices are reconnected to each other after being interrupted due to a reason.

According to a first aspect, a BLUETOOTH device connection method is provided. The method includes scanning, by a primary end device having a BLUETOOTH function, for a target BLUETOOTH device within communication coverage after a connection established between BLUETOOTH devices is disconnected, where the target BLUETOOTH device is preselected from BLUETOOTH devices that have been paired with the primary end device; if there is a target BLUETOOTH device in the communication coverage of the primary end device, sending, by the primary end device, a connection request to the target BLUETOOTH device; and receiving, by the primary end device, response information sent by the target BLUETOOTH device, so that a connection is established between the primary end device and the target BLUETOOTH device.

With reference to the first aspect, in a first possible implementation manner, that the target BLUETOOTH device is preselected from BLUETOOTH devices that have been paired with the primary end device includes that the target BLUETOOTH device is a BLUETOOTH device that is to perform fixed connection and preselected from BLUETOOTH devices that have been paired with the primary end device; or the target BLUETOOTH device is a BLUETOOTH device that is paired with the primary end device at a last time.

With reference to the first aspect or the first possible implementation manner, in a second possible implementation manner, before the scanning, by a primary end device, for a target BLUETOOTH device within communication coverage, the method further includes scanning, by the primary end device, for searchable BLUETOOTH devices within the communication coverage; if there are the searchable BLUETOOTH devices, sending, by the primary end device, a pairing request to one of the BLUETOOTH devices; and receiving, by the primary end device, a pairing response message sent by the one BLUETOOTH device, so that pairing is established between the primary end device and the one BLUETOOTH device.

With reference to the first aspect or the first possible implementation manner or the second possible implementation manner, in a third possible implementation manner, after the connection is established between the primary end device and the target BLUETOOTH device, the method includes sending, by the primary end device, a voice connection request to the target BLUETOOTH device; and receiving, by the primary end device, a voice connection response message sent by the target BLUETOOTH device, so that a voice connection is established between the primary end device and the target BLUETOOTH device.

According to a second aspect, an embodiment of the present invention provides a primary end device having a BLUETOOTH function, including a scanning unit configured to scan for a target BLUETOOTH device within communication coverage of the primary end device after a connection established between BLUETOOTH devices is disconnected, where the target BLUETOOTH device is preselected from BLUETOOTH devices that have been paired with the primary end device; a sending unit configured to send a connection request to the target BLUETOOTH device if there is a target BLUETOOTH device in the communication coverage of the primary end device; and a receiving unit configured to receive response information sent by the target BLUETOOTH device, so that a connection is established between the primary end device and the target BLUETOOTH device.

With reference to the second aspect, in a first possible implementation manner, the target BLUETOOTH device is a BLUETOOTH device that is to perform fixed connection and preselected from BLUETOOTH devices that have been paired with the primary end device; or the target BLUETOOTH device is a BLUETOOTH device that is paired with the primary end device at a last time.

With reference to the second aspect or the first possible implementation manner, in a second possible implementation manner, the scanning unit is further configured to, before scanning for a target BLUETOOTH device within the communication coverage of the primary end device, scan for searchable BLUETOOTH devices within the communication coverage of the primary end device; the sending unit is further configured to send a pairing request to one of the BLUETOOTH devices if there are the searchable BLUETOOTH devices; and the receiving unit is further configured to receive a pairing response message sent by the one BLUETOOTH device, so that pairing is established between the primary end device and the one BLUETOOTH device.

With reference to the second aspect or the first possible implementation manner or the second possible implementation manner, in a third possible implementation manner, the sending unit is further configured to send a voice connection request to the target BLUETOOTH device after a connection is established between the primary end device and the target BLUETOOTH device; and the receiving unit is further configured to receive a voice connection response message sent by the target BLUETOOTH device, so that a voice connection is established between the primary end device and the target BLUETOOTH device.

Embodiments of the present invention provide a BLUETOOTH device connection method and a device. After a connection established between BLUETOOTH devices is disconnected, a primary end device having a BLUETOOTH function scans for a target BLUETOOTH device within communication coverage, where the target BLUETOOTH device is preselected from BLUETOOTH devices that have been paired with the primary end device. If there is a target BLUETOOTH device in the communication coverage of the primary end device, the primary end device sends a connection request to the target BLUETOOTH device. The primary end device receives response information sent by the target BLUETOOTH device, so that a connection is established between the primary end device and the target BLUETOOTH device. In this way, it is implemented that, when the BLUETOOTH devices are reconnected to each other after being interrupted due to a reason, the primary end device having a BLUETOOTH function proactively sends a connection request to a target BLUETOOTH device, so that a step of manually initiating a connection by a user is omitted, and a BLUETOOTH connection is established more timely, thereby improving BLUETOOTH communication efficiency.

### BRIEF DESCRIPTION OF THE DRAWINGS

To describe the technical solutions in the embodiments of the present invention or in the prior art more clearly, the following briefly introduces the accompanying drawings required for describing the embodiments or the prior art. The accompanying drawings in the following description show merely some embodiments of the present invention, and a person of ordinary skill in the art may still derive other drawings from these accompanying drawings without creative efforts.

FIG. 1 is a schematic diagram of a BLUETOOTH device connection method according to an embodiment of the present invention;

FIG. 2 is a schematic diagram of another BLUETOOTH device connection method according to an embodiment of the present invention;

FIG. 3 is a schematic diagram of a primary end device according to an embodiment of the present invention;

FIG. 4 is a schematic diagram of another primary end device according to an embodiment of the present invention; and

FIG. 5 is a schematic diagram of a BLUETOOTH protocol stack in the prior art.

### DETAILED DESCRIPTION

The following clearly describes the technical solutions in the embodiments of the present invention with reference to the accompanying drawings in the embodiments of the present invention. The described embodiments are merely some but not all of the embodiments of the present invention. All other embodiments obtained by a person of ordinary skill in the art based on the embodiments of the present invention without creative efforts shall fall within the protection scope of the present invention.

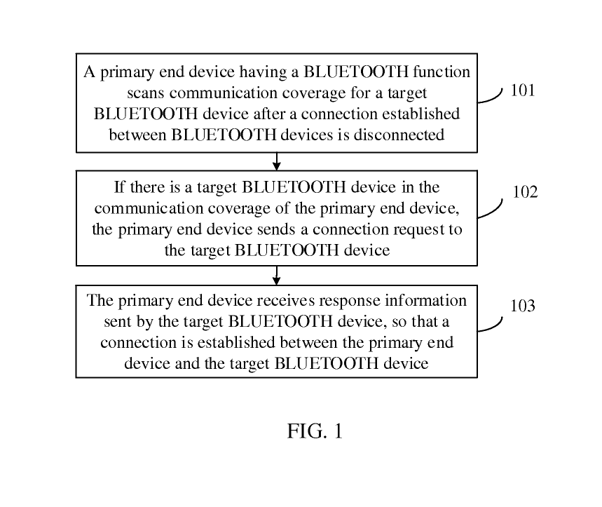

Referring to FIG. 1, an embodiment of the present invention provides a BLUETOOTH device connection method, where the method includes the following steps.

101. A primary end device having a BLUETOOTH function scans for a target BLUETOOTH device within communication coverage after a connection established between BLUETOOTH devices is disconnected, where the target BLUETOOTH device is preselected from BLUETOOTH devices that have been paired with the primary end device.

A BLUETOOTH technology specifies that during communication between each pair of BLUETOOTH devices, one is a primary device and the other is a secondary device; and both the primary device and the secondary device may receive and send data only after the primary device performs scanning and searching and initiates pairing. In this embodiment of the present invention, the primary end device serves as a primary device. Although a primary end device is used to facilitate description, the primary end device is also a BLUETOOTH device.

There may be multiple BLUETOOTH devices that have been paired with the primary end device. Therefore, when the primary end device needs to re-establish a connection, one target BLUETOOTH device to be connected should be determined from the multiple BLUETOOTH devices that have been paired, so as to ensure directionality for sending information, so that the primary end device only scans for the target BLUETOOTH device within communication coverage of the primary end device, so as to automatically connect to the target BLUETOOTH device that needs to be connected by a user.

Preferably, the target BLUETOOTH device is a BLUETOOTH device that is to perform fixed connection and preselected from BLUETOOTH devices that have been paired with the primary end device. For example, the user selects one BLUETOOTH device for a subsequent fixed connection with the BLUETOOTH device, and then subsequent scanning is only performed on the BLUETOOTH device; alternatively, the target BLUETOOTH device is a BLUETOOTH device that is paired with the primary end device at a last time, for example, a BLUETOOTH device that is paired at a last time before a connection is disconnected is selected by default. Therefore, when the primary end device having a BLUETOOTH function and the target BLUETOOTH device are reconnected to each other after being disconnected, the primary end device only scans for a target BLUETOOTH device within the communication coverage. It should be noted that, a manner of selecting a target BLUETOOTH device may be changed or disabled by the user at any time, which is not limited herein in the present invention and aims to describe that a target BLUETOOTH device needs to be preselected from the BLUETOOTH devices that have been paired with the primary end device.

102. If there is a target BLUETOOTH device in the communication coverage of the primary end device, the primary end device sends a connection request to the target BLUETOOTH device.

Communication between BLUETOOTH devices is established by using a BLUETOOTH protocol stack. A BLUETOOTH protocol stack is shown in FIG. 5, from which it is seen that sending of a connection request is on a basis of a connection of a Radio Frequency Communications protocol layer and a link layer above the Radio Frequency Communications protocol layer. The foregoing process may be implemented by pairing the BLUETOOTH devices. A connection of a link layer below the Radio Frequency Communications protocol layer may be used for performing data transmission only after the pairing is completed.

To implement the foregoing process, the primary end device needs to scan for the target BLUETOOTH device within the communication coverage. If there is a target BLUETOOTH device, the primary end device needs to send a connection request to the target BLUETOOTH device, where the connection request at least includes account information, a modem command (AT command), and network layer access information of the primary end device, so as to implement establishment of a synchronous connection oriented link (SCO), and a connection or a link of a lower layer. In the prior art, a user needs to press a connection button on a BLUETOOTH device to implement sending of a connection request. For example, the BLUETOOTH device and a BLUETOOTH headset are in a conversation, but the conversation is interrupted due to a reason, for example, the BLUETOOTH device and the BLUETOOTH headset are out of communication coverage; when a surrounding conversation environment is restored to normal, for example, the BLUETOOTH device and the BLUETOOTH headset are in the communication coverage again, the conversation may be continued only after the user presses a connection button on the BLUETOOTH device or the BLUETOOTH headset. In this embodiment of the present invention, when a surrounding conversation environment is normal, for example, the primary end device and the target BLUETOOTH device are in the communication coverage again, the primary end device proactively sends a connection request to the target BLUETOOTH device, that is, the BLUETOOTH device proactively sends a connection request to a target BLUETOOTH headset of the BLUETOOTH device, thereby omitting a step of manually connecting by the user.

A function of proactively sending a connection request by the primary end device is implemented by installing application software and controls in the primary end device or adding a language for automatically sending a connection request during programming. It should be noted that, the function of proactively sending a connection request by the primary end device provided in this embodiment of the present invention may be a newly-add operation mode, which is provided for a user for selective use. The user may enable or disable this operation mode, which is not limited herein.

103. The primary end device receives response information sent by the target BLUETOOTH device, so that a connection is established between the primary end device and the target BLUETOOTH device.

After receiving the connection request sent by the primary end device, the target BLUETOOTH device confirms the connection request, and sends response information according to the connection request. Due to previous pairing, after a process of polling information exchange, a data connection is established between the primary end device and the target BLUETOOTH device.

A person skilled in the art may understand that embodiments of the present invention may not mean that a request must be initiated by a primary end device or that the request must be received by a target BLUETOOTH device. In practice, roles may be exchanged. The primary end device and the target BLUETOOTH device are merely two BLUETOOTH devices involved when a request has been initiated, which facilitates description.

This embodiment of the present invention provides a BLUETOOTH device connection method, which implements that when BLUETOOTH devices are reconnected to each other after being interrupted due to a reason, a primary end device having a BLUETOOTH function proactively sends a connection request to a target BLUETOOTH device, so that a step of manually initiating a connection by a user is omitted, and a BLUETOOTH connection is established more timely, thereby improving BLUETOOTH communication efficiency.

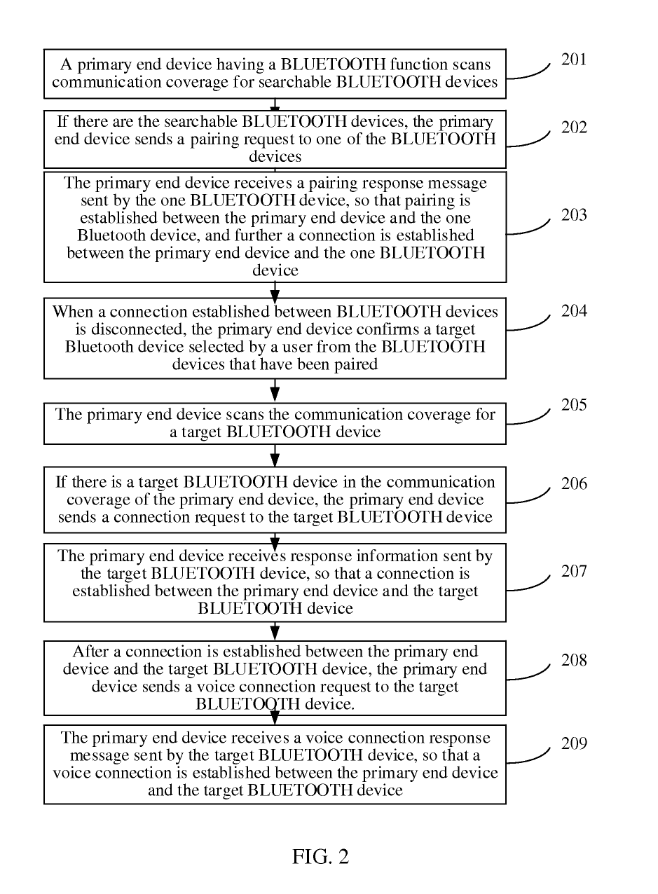

Referring to FIG. 2, an embodiment of the present invention provides another BLUETOOTH device connection method, where the method includes the following steps.

201. A primary end device having a BLUETOOTH function scans for searchable BLUETOOTH devices within communication coverage.

A BLUETOOTH technology specifies that during communication between each pair of BLUETOOTH devices, one is a primary device and the other is a secondary device; and both the primary device and the secondary device may receive and send data only after the primary device performs searching and initiates pairing. In this embodiment of the present invention, the primary end device serves as a primary device. During communication, the primary end device first performs scanning to find the searchable BLUETOOTH devices within the communication coverage of the primary end device. Although a primary end device is used to facilitate description, the primary end device is also a BLUETOOTH device.

202. If there are the searchable BLUETOOTH devices, the primary end device sends a pairing request to one of the BLUETOOTH devices.

The primary end device sends a pairing request to one of the BLUETOOTH devices, where the pairing request at least includes personal identification number (PIN) of the one BLUETOOTH device and an address of the primary end device.

Communication between BLUETOOTH devices is established by using a BLUETOOTH protocol stack. A BLUETOOTH protocol stack is shown in FIG. 5, from which it is seen that sending of a connection request is on a basis of a connection of a Radio Frequency Communications protocol layer and a link layer above the Radio Frequency Communications protocol layer.

To implement the foregoing process, the primary end device needs to pair with one of the BLUETOOTH devices after finding the searchable BLUETOOTH devices within the communication coverage of the primary end device. In this case, the PIN of the one BLUETOOTH device needs to be entered, where generally a PIN of a BLUETOOTH headset is 1234 or 0000 by default, and a PIN of a stereo BLUETOOTH headset is 8888, and a PIN of a smart terminal can be set by a user. The primary end device packs information such as the PIN code, and the address of the primary end device into a pairing request, and then sends the pairing request to the one BLUETOOTH device. In the prior art, some BLUETOOTH devices are always in a searchable state, and some BLUETOOTH devices can be found only if a user performs setting.

203. The primary end device receives a pairing response message sent by the one BLUETOOTH device, so that pairing is established between the primary end device and the one BLUETOOTH device, and further a connection is established between the primary end device and the one BLUETOOTH device.

After receiving the pairing request message sent by the primary end device, the one BLUETOOTH device authenticates this message. If the message is correct, the one BLUETOOTH device sends confirmation information and implements pairing with the primary end device. For a BLUETOOTH device that has been paired, the primary end device has already stored pairing information and re-pairing is no longer needed upon a next call.

A person skilled in the art may understand that, steps 201 to 203 are introduced to facilitate understanding of completeness of a procedure, but are not mandatory steps. For example, in a case in which pairing has been performed between BLUETOOTH devices, pairing is not needed.

204. When a connection established between BLUETOOTH devices is disconnected, the primary end device confirms a target BLUETOOTH device selected by a user from the BLUETOOTH devices that have been paired.

Before the primary end device needs to re-establish a connection, one target BLUETOOTH device to be connected should be determined, so as to ensure directionality for sending information, so that subsequently the primary end device only scans for the target BLUETOOTH device within communication coverage of the primary end device, so as to automatically connect to the target BLUETOOTH device that needs to be connected by a user.

Preferably, the target BLUETOOTH device is a BLUETOOTH device that is to perform a fixed connection and preselected from BLUETOOTH devices that have been paired with the primary end device. For example, the user selects one BLUETOOTH device, and subsequent scanning is only performed on the BLUETOOTH device; alternatively, the target BLUETOOTH device is a BLUETOOTH device that is paired with the primary end device at a last time, for example, a BLUETOOTH device that is paired at a last time before a connection is disconnected is selected by default. A manner of selecting a target BLUETOOTH device may be changed or disabled by the user at any time, which is not limited herein in the present invention and aims to describe that a target BLUETOOTH device needs to be preselected from the BLUETOOTH devices that have been paired with the primary end device.

Step 204 involves a setting step, and a person skilled in the art may understand that the setting step in the procedure is not necessary each time. If the manner of selecting a target BLUETOOTH device is previously selected and is not disabled or changed afterwards, or the primary end device is previously set to be, by default, a BLUETOOTH device that is paired at a last time, setting is not needed.

205. The primary end device scans for a target BLUETOOTH device within the communication coverage.

206. If there is a target BLUETOOTH device in the communication coverage of the primary end device, the primary end device sends a connection request to the target BLUETOOTH device.

After the target BLUETOOTH device is selected, data transmission may be performed only after a connection of a link layer below a Radio Frequency Communications protocol layer is implemented. To implement this connection, the primary end device first needs to scan for the target BLUETOOTH device within the communication coverage of the primary end device. If there is a target BLUETOOTH device, the primary end device sends a connection request to the target BLUETOOTH device, where the connection request at least includes account information, an AT command, and network layer access information of the primary end device, so as to implement establishment of an SCO, and a connection or a link of a lower layer. In the prior art, a user needs to press a connection button on a BLUETOOTH device to implement sending of a connection request. For example, the BLUETOOTH device and a BLUETOOTH headset are in a conversation, but the conversation is interrupted due to a reason, for example, the conversation is interrupted because the BLUETOOTH device and the BLUETOOTH headset are out of communication coverage; when a surrounding conversation environment is restored to normal, for example, the BLUETOOTH device and the BLUETOOTH headset are in the communication coverage again, the conversation may be continued only after the user presses a connection button on the BLUETOOTH device or the BLUETOOTH headset. In this embodiment of the present invention, when the surrounding conversation environment is normal, for example, the primary end device and the target BLUETOOTH device are in the communication coverage again, the primary end device proactively sends a connection request to the target BLUETOOTH device, so that a BLUETOOTH connection is established more timely, a step of manually connecting by the user is omitted.

A function of proactively sending a connection request by the primary end device is implemented by installing application software and controls on the primary end device or adding a language for automatically sending a connection request during programming. It should be noted that, the function of proactively sending a connection request by the primary end device provided by this embodiment of the present invention may be a newly-added operation mode, which is provided for a user for selective use. The user may enable or disable this operation mode, which is not limited herein.

207. The primary end device receives response information sent by the target BLUETOOTH device, so that a connection is established between the primary end device and the target BLUETOOTH device.

After receiving the connection request sent by the primary end device, the target BLUETOOTH device confirms the connection request, and sends response information according to the connection request; and the primary end device receives the response information. Due to previous pairing, after a process of polling information exchange is performed, a connection is established between the primary end device and the target BLUETOOTH device.

208. After a connection is established between the primary end device and the target BLUETOOTH device, the primary end device sends a voice connection request to the target BLUETOOTH device.

209. The primary end device receives a voice connection response message sent by the target BLUETOOTH device, so that a voice connection is established between the primary end device and the target BLUETOOTH device.

It is seen from FIG. 5 that in the BLUETOOTH protocol stack, after establishment of a data connection is completed, only an audio transmission application protocol needs to be established; then the voice connection may be performed. Therefore, the primary end device sends a voice connection request to the target BLUETOOTH device; and the target BLUETOOTH device sends a voice connection response message for confirmation on the voice connection; and performs the voice connection with the primary end device after the primary end device receives the voice connection response message.

A person skilled in the art may understand that, no limitation is set on a sequence of the foregoing steps 201 to 209.

In addition, a person skilled in the art may understand that embodiments of the present invention may not mean that a request must be initiated by a primary end device or that the request must be received by a target BLUETOOTH device. In practice, roles may be exchanged. The primary end device and the target BLUETOOTH device are merely two BLUETOOTH devices involved when a request has been initiated, which facilitates description.

This embodiment of the present invention provides a BLUETOOTH device connection method, which implements that when BLUETOOTH devices are reconnected to each other after being interrupted due to a reason, a primary end device having a BLUETOOTH function proactively sends a connection request to a target BLUETOOTH device, so that a step of manually initiating a connection by a user is omitted, and a BLUETOOTH connection is established more timely, thereby improving BLUETOOTH communication efficiency.

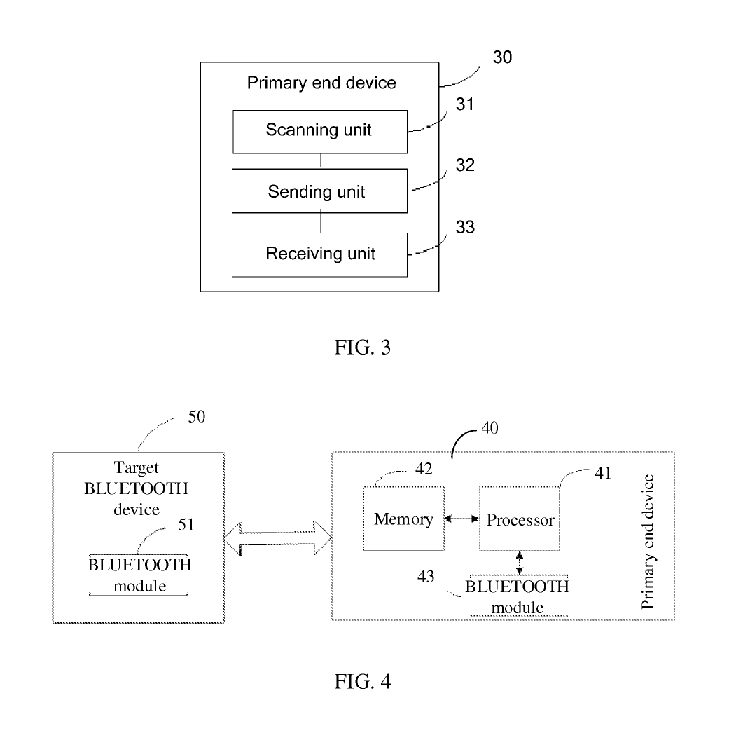

Referring to FIG. 3, an embodiment of the present invention provides a primary end device 30 having a BLUETOOTH function, including a scanning unit 31, a sending unit 32, and a receiving unit 33.

The scanning unit 31 is configured to scan for a target BLUETOOTH device within communication coverage of the primary end device 30 after a connection established between BLUETOOTH devices is disconnected, where the target BLUETOOTH device is preselected from BLUETOOTH devices that have been paired with the primary end device 30.

Preferably, the target BLUETOOTH device is a BLUETOOTH device that is to perform a fixed connection and preselected from BLUETOOTH devices that have been paired with the primary end device 30; alternatively, the target BLUETOOTH device is a BLUETOOTH device that is paired with the primary end device 30 at a last time. Therefore, the primary end device 30 only scans for a target BLUETOOTH device within the communication coverage.

The sending unit 32 is configured to, if there is a target BLUETOOTH device in the communication coverage of the primary end device 30, send a connection request to the target BLUETOOTH device.

The receiving unit 33 is configured to receive response information sent by the target BLUETOOTH device, so that a data connection is established between the primary end device 30 and the target BLUETOOTH device.

Further, the scanning unit 31 is further configured to scan for searchable BLUETOOTH devices within the communication coverage of the primary end device 30.

The sending unit 32 is further configured to, if there are the searchable BLUETOOTH devices, send a pairing request to one of the BLUETOOTH devices, where the pairing request at least includes a PIN of the one BLUETOOTH device, and an address of the primary end device.

The receiving unit 33 is further configured to receive a pairing response message sent by the one BLUETOOTH device, so that pairing is established between the primary end device 30 and the one BLUETOOTH device, and further a connection is established between the primary end device 30 and the one BLUETOOTH device.

Further, the sending unit 32 is further configured to send a voice connection request to the target BLUETOOTH device.

The receiving unit 33 is further configured to receive a voice connection response message sent by the target BLUETOOTH device, so that a voice connection is established between the primary end device 30 and the target BLUETOOTH device.

This embodiment of the present invention provides a primary end device, which implements that when BLUETOOTH devices are reconnected to each other after being interrupted due to a reason, a primary end device having a BLUETOOTH function proactively sends a connection request to a target BLUETOOTH device, so that a step of manually initiating a connection by a user is omitted, and a BLUETOOTH connection is established more timely, thereby improving BLUETOOTH communication efficiency.

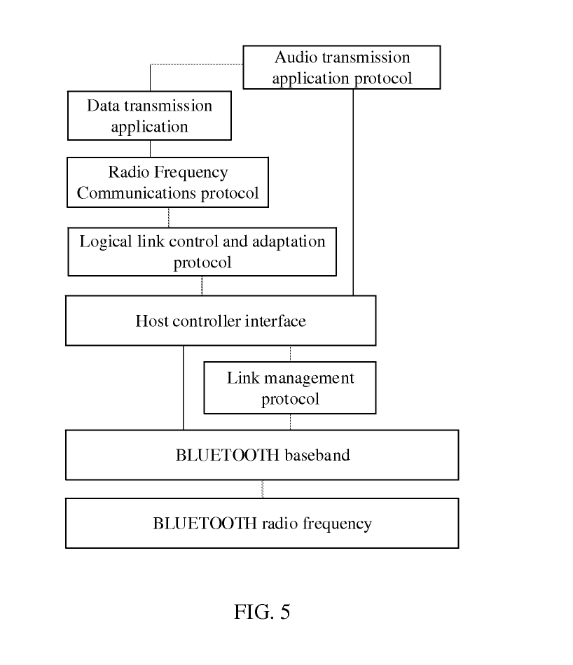

Referring to FIG. 4, an embodiment of the present invention provides a primary end device 40 having a BLUETOOTH function and a target BLUETOOTH device 50, where the primary end device includes a processor 41, a memory 42, and a BLUETOOTH module 43; and the target BLUETOOTH device includes a BLUETOOTH module 51.

The processor 41 of the primary end device 40 is a control center of the primary end device 40, which uses various interfaces and lines to connect to parts of the entire primary end device 40, runs or executes a software program and/or a module stored in the memory 42, invokes data stored in the memory 42, executes various functions of the primary end device 40, and processes data, so as to perform overall monitoring on the primary end device 40. Optionally, the processor 41 may include one or more processing units.

The memory 42 may be configured to store a software program and a module, and the processor 41 executes various functional applications of the primary end device 40 and processes data by running the software program and the module that are stored in the memory 42. The memory 42 mainly includes a program storage area and a data storage area, where the program storage area may store an operating system, and an application program needed by at least one function (such as an audio playing function or an image displaying function), and the like; and the data storage area may store data (such as audio data or a phonebook) created according to use of the primary end device 40, and the like. In addition, the memory 42 may include a high-speed random access memory, and may further include a nonvolatile memory, for example, at least one magnetic disk storage device, a flash device, or another volatile solid-state storage device.

The BLUETOOTH module 43 has an on-chip digital radio processor, a numerically controlled oscillator, an on-chip radio frequency transceiver switch and a built-in embedded processor, and the like (which are not shown), which can implement wireless communication between BLUETOOTH devices.

In this embodiment of the present invention, the BLUETOOTH module 43 of the primary end device 40 having a BLUETOOTH function scans for searchable BLUETOOTH devices within the communication coverage of the primary end device 40. If there are the searchable BLUETOOTH devices, the processor 41 invokes information such as a PIN of one of the BLUETOOTH devices, and the address of the primary end device 40 from the memory 42, and packs them into a pairing request, and the pair request is sent by a transceiver apparatus (which is not shown) of the BLUETOOTH module 43 to the one BLUETOOTH device. After receiving the pairing request message sent by the primary end device 40, the one BLUETOOTH device authenticates this message. If the message is correct, the one BLUETOOTH device sends confirmation information. The transceiver apparatus of the BLUETOOTH module 43 receives a pairing response message sent by the one BLUETOOTH device, so that pairing is established between the primary end device 40 and the one BLUETOOTH device. For a BLUETOOTH device that has been paired, the memory 42 of the primary end device has already stored pairing information and re-pairing is no longer needed upon a next call.

Further, the BLUETOOTH module 43 scans for a target BLUETOOTH device within the communication coverage of the primary end device 40 after a connection established between BLUETOOTH devices is disconnected. The target BLUETOOTH device is selected from the BLUETOOTH devices that have been paired with the primary end device 40. Preferably, the target BLUETOOTH device is a BLUETOOTH device that is to perform a fixed connection and preselected from the BLUETOOTH devices that have been paired with the primary end device; alternatively, the target BLUETOOTH device is a BLUETOOTH device that is paired with the primary end device at a last time. The present invention does not set a specific limitation herein. If there is a target BLUETOOTH device within the communication coverage of the primary end device 40, the processor 41 invokes information, such as account information, an AT command, and network layer access information, of the primary end device 40 in the memory 42, packs them into a connection request, and instructs the transceiver apparatus of the BLUETOOTH module 43 to send a connection request to the target BLUETOOTH device. After receiving the connection request sent by the transceiver apparatus of the BLUETOOTH module 43, the target BLUETOOTH device confirms the connection request and sends response information according to the connection request. The transceiver apparatus of the BLUETOOTH module 43 receives the response information send by the target BLUETOOTH device, and after a process of polling information exchange is performed, a connection is established between the primary end device 40 and the target BLUETOOTH device.

Optionally, the transceiver apparatus of the BLUETOOTH module 43 is further configured to send a voice connection request to the target BLUETOOTH device, and after receiving the voice connection request, the target BLUETOOTH device sends a voice connection response message. The transceiver apparatus of the BLUETOOTH module 43 receives the voice connection response message sent by the target BLUETOOTH device, so that a voice connection is established between the primary end device 40 and the target BLUETOOTH device.

This embodiment of the present invention provides a primary end device, which implements that when BLUETOOTH devices are reconnected to each other after being interrupted due to a reason, a primary end device having a BLUETOOTH function proactively sends a connection request to a target BLUETOOTH device, so that a step of manually initiating a connection by a user is omitted, and a BLUETOOTH connection is established more timely, thereby improving BLUETOOTH communication efficiency.

A person of ordinary skill in the art may understand that all or some of the steps of the methods in the embodiments may be implemented by a program instructing relevant hardware. The program may be stored in a computer-readable storage medium. The storage medium may include a read-only memory (ROM), a random access memory (RAM), a magnetic disk, an optical disc, or the like.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A BLUETOOTH device connection method, comprising:
scanning, by a primary BLUETOOTH device, for a target BLUETOOTH device within communication coverage after a connection established between the primary BLUETOOTH device and another BLUETOOTH device is disconnected, wherein the target BLUETOOTH device is preselected from BLUETOOTH devices that have been paired with the primary BLUETOOTH device;
sending, by the primary BLUETOOTH device, a connection request to the target BLUETOOTH device when the target BLUETOOTH device is found within the communication coverage of the primary BLUETOOTH device; and
receiving, by the primary BLUETOOTH device, a response sent by the target BLUETOOTH device such that a connection is established between the primary BLUETOOTH device and the target BLUETOOTH device.

2. The method according to claim 1, wherein the target BLUETOOTH device is a BLUETOOTH device that is to perform a fixed connection and that is preselected from BLUETOOTH devices that have been paired with the primary BLUETOOTH device.

3. The method according to claim 1, wherein the target BLUETOOTH device is a BLUETOOTH device that is paired with the primary BLUETOOTH device at a last time.

4. The method according to claim 1, wherein before scanning, by the primary BLUETOOTH device, for the target BLUETOOTH device within the communication coverage, the method further comprises:
scanning, by the primary BLUETOOTH device, for searchable BLUETOOTH devices within the communication coverage;
sending, by the primary BLUETOOTH device, a pairing request to one of a found BLUETOOTH devices when the BLUETOOTH devices are found; and
receiving, by the primary BLUETOOTH device, a pairing response sent by the one BLUETOOTH device such that pairing is established between the primary BLUETOOTH device and the one BLUETOOTH device.

5. The method according to claim 1, wherein after the connection is established between the primary BLUETOOTH device and the target BLUETOOTH device, the method comprises:
sending, by the primary BLUETOOTH device, a voice connection request to the target BLUETOOTH device; and
receiving, by the primary BLUETOOTH device, a voice connection response sent by the target BLUETOOTH device such that a voice connection is established between the primary BLUETOOTH device and the target BLUETOOTH device.

6. A primary BLUETOOTH device, comprising:
a scanning unit configured to scan for a target BLUETOOTH device within communication coverage of the primary BLUETOOTH device after a connection established between the primary BLUETOOTH device and another BLUETOOTH device is disconnected, wherein the target BLUETOOTH device is preselected from BLUETOOTH devices that have been paired with the primary BLUETOOTH device;
a sending unit configured to send a connection request to the target BLUETOOTH device when a target BLUETOOTH device is found within the communication coverage of the primary BLUETOOTH device; and
a receiving unit configured to receive a response sent by the target BLUETOOTH device such that a connection is established between the primary BLUETOOTH device and the target BLUETOOTH device.

7. The primary BLUETOOTH device according to claim 6, wherein the target BLUETOOTH device is a BLUETOOTH device that is to perform a fixed connection and that is preselected from BLUETOOTH devices that have been paired with the primary BLUETOOTH device.

8. The primary BLUETOOTH device according to claim 6, wherein the target BLUETOOTH device is a BLUETOOTH device that is paired with the primary BLUETOOTH device at a last time.

9. The primary BLUETOOTH device according to claim 6, wherein the scanning unit is further configured to scan for searchable BLUETOOTH devices within the communication coverage of the primary BLUETOOTH device before scanning for the target BLUETOOTH device within the communication coverage of the primary BLUETOOTH device, wherein the sending unit is further configured to send a pairing request to one of the BLUETOOTH devices when BLUETOOTH devices are found, and wherein the receiving unit is further configured to receive a pairing response sent by the one BLUETOOTH device such that pairing is established between the primary BLUETOOTH device and the one BLUETOOTH device.

10. The primary BLUETOOTH device according to claim 6, wherein the sending unit is further configured to send a voice connection request to the target BLUETOOTH device after the connection is established between the primary BLUETOOTH device and the target BLUETOOTH device, and wherein the receiving unit is further configured to receive a voice connection response sent by the target BLUETOOTH device such that a voice connection is established between the primary BLUETOOTH device and the target BLUETOOTH device.
